(19) United States
(12) Patent Application Publication
(10) Pub. No.: US 2009/0016147 A1
(43) Pub. Date: Jan. 15, 2009

(54) SCREW ELEMENT FOR USE AS A KNEADING ELEMENT IN A PLASTICIZING UNIT

(75) Inventors: MICHAEL BEHLING, Hameln (DE); Ralf J. Dahl, Isernhagen (DE)

Correspondence Address: Henry M. Feiereisen;Henry M. Feiereisen, LLC, Suite 1501, 708 Third Avenue, New York, NY, 10017, US

(73) Assignee: KraussMaffei Berstorff GmbH, Hannover (DE)

(21) Appl. No.: 12/211,410

(22) Filed: Sep. 16, 2008

Related U.S. Application Data
(63) Continuation of application No. PCT/EP07/02482, filed on Mar. 21, 2007.

(30) Foreign Application Priority Data
Mar. 28, 2006 (DE) 10 2006 014 692.1

(51) Int. Cl. B28C 1/16

(52) U.S. Cl. 366/69

(57) ABSTRACT

A screw element for use as a kneading element in a plasticizing unit includes at least two kneading units which can be arranged on a common axis, for example a screw shaft. The kneading units have a geometry which is designed for attaining particularly good plasticization and reduced mechanical stress in such a way that the geometry of at least two successively arranged kneading units differs.

### CROSS-REFERENCES TO RELATED APPLICATIONS

This application is a continuation of prior filed copending PCT International application no. PCT/EP2007/002482, filed Mar. 21, 2007, which designated the United States and has been published but not in English as International Publication No. WO 2007/112861 and on which priority is claimed under 35U.S.C. §120, and which claims the priority of German Patent Application, Serial No. 10 2006 014 692.1, filed Mar. 28, 2006, pursuant to 35 U.S.C. 119(a)-(d), the contents of which are incorporated herein by reference in its entirety as if fully set forth herein.

### BACKGROUND OF THE INVENTION

The present invention relates, in general, to a screw element, and more particularly to a screw element for use as a kneading element for a plasticizing unit.

Nothing in the following discussion of the state of the art is to be construed as an admission of prior art.

Many different processes are applied to process plastics in a plasticizing unit of an extruder or injection molding machine. One such process involves compounding, i.e. admixture of filling or reinforcing agents, incorporating dyes or pigments, blending various materials, like e.g. plastics or elastomers, reactive processes, or the like. Common to all these processes is their implementation by two extruders including two or more shafts and having screws that rotate in a same direction or in opposite direction. Shear energy for melting the plastic materials is introduced into the material by these screws. The screws have so-called screw elements which oftentimes have multi-threaded configuration.

A special screw element is the so-called kneading element, also called kneading block in the art. Such a kneading block is made of spiral-shaped screw parts or several kneading units disposed behind one another in processing direction and having a certain geometry. Kneading elements have kneading units of a geometry which is the same especially as far as their width and their outer and inner diameters are concerned and is selected in accordance with the size of the plasticizing unit, i.e. the plasticizing unit of the extruder or the injection molding machine.

Dissipation of mechanical energy, introduced via the drive, via the gear train, and via the screw shaft, is determined by the type of used screw structure besides for example in dependence on the enthalpy of the plastic being processed. The type of the used screw structure is also called configuration. The configuration varies for example by the type and number of kneading blocks and the other screw elements.

The main conversion of energy is primarily realized directly anteriorly as well as over the first kneading element(s) in dependence of the geometry of the screw elements. The main conversion of the energy is realized by shearing. Primarily determinative are hereby the rotation speed of the screw and thus the (angular) speed of the kneading units, the gap between the kneading unit and the extruder barrel as well as the kneading units in the gusset zone and the flight land area of the kneading element, when twin-screw extruders are involved. The shear rate as well as the shear stress can be calculated accordingly from these variables. Melting of the material to be plasticized can be established on the basis of the shear stress. The highest mechanical stress on the screw element and its shaft/hub connection is encountered during melting.

It would therefore be desirable and advantageous to provide an improved screw element to obviate prior art shortcomings and to allow good plasticization of the material to be processed while reducing the mechanical stress on the screw element.

### SUMMARY OF THE INVENTION

According to one aspect of the present invention, a kneading element for a plasticizing unit, comprising at least three kneading units arranged successively on a common axis, said kneading units having a width which increases overall in a processing direction, wherein the kneading units have portions of same width.

The present invention resolves prior art problems by providing a screw element for use as a kneading element whose successively arranged kneading units have different geometry, with the width of the kneading units increasing in processing direction. The width of the kneading units may thus vary. As a result, the shearing clearance is influenced in such a manner that the shearing area changes. This may also be implemented within one or more successive screw elements like—as will be explained hereinafter—when the diameter of the kneading unit changes. The kneading units or screw parts have throughout no same width across the width of the screw element. Moreover, the kneading units or screw part sections may have also no same diameter throughout. The screw elements can be irrespective of the number of elements in the screw. Thus, the disk-land width variability could extend over several screw elements. The screw elements can thus be length-independent.

The width of the kneading units increases overall in processing direction. As a result, also shearing of the material to be plasticized increases in processing direction. Processing direction is defined as the direction of the plasticizing unit in which the material to be plasticized and/or the plasticized material is transported. The progression of the variability of the width of the kneading units does not have to increase steadily however, but may also be partly the same.

According to another feature of the present invention, the screw element has a screw shaft which defines the common axis on which the kneading units are arranged.

According to another feature of the present invention, one of the kneading units is defined by a first diameter, and the other one of the kneading unit is defined by a second diameter which is different than the first diameter. Suitably, the first and second diameters increase in the processing direction.

In summary, it has been recognized that good plasticization can be realized while reducing the mechanical stress on the screw element by deviating from the conventional shape of same geometry of the kneading units. Selecting different geometries, namely different widths, of the kneading units enables control of the shear introduction and the mechanical stress and optimization of the respective process.

The use of the screw elements according to the invention is possible for a number of plasticizing units and a wide variety of processes. The screw element according to the invention may represent a kneading element which is applicable for two-shaft or multi-shaft plasticizing units which rotate in a same direction or in opposite direction. It is also possible to design the screw elements single-threaded or multi-threaded, to configure them of spiral-shaped screw parts or integral or to make them of loosely interconnected kneading units. The kneading units are selected in dependence on the size of the plasticizing unit and the respective process task. The configuration of the screw element in accordance with the invention is thus independent of the machine size and the diameter of the screw element. Further, the screw element can be constructed independent of the type of the shaft/hub connection as well as number of threads of the screw element. The screw elements can further be used for any type of material to be plasticized and are independent of the DA/Dᵢ ratio as well as rotation direction of the screws.

The geometry can be configured in such a manner as to attain a continuous increase of shear of the material to be plasticized. This is beneficial because shear is introduced not massively and suddenly but smoothly, for example steadily increasing. As a result, the screw element is exposed to stress more dynamically over a longer path rather than locally harshly in a narrow restricted region.

As stated above, the diameter of at least two kneading units may differ. As a result, the shearing clearance formed between the kneading unit and the extruder barrel would be designed greater or smaller in processing direction. The diameters of the individual kneading units or sections may hereby increase in processing direction. The kneading units as well as kneading elements arranged in succession may hereby have throughout different diameters.

The progression of the diameter does not necessarily have to steadily increase but may partly also be the same or decrease. Depending on the process task, all possible variations of the diameter are conceivable. The diameter variability may hereby extend over various screw elements.

When the diameter of the kneading units increases in processing direction, the screw element is exposed to mechanical stress in an increasingly dynamic manner over a longer path. The progression of the variability of the diameter of the kneading units does not necessarily have to increase steadily, rather it may also partly be the same or decrease.

The variability of the geometry has thus a direct influence on the development of the shear rate and the shear stress anteriorly of and in the screw element as well as on the development of the mechanical stress on the elements. Further, the Dₐ/Dᵢ ratio of the kneading units may be constant or vary for the screw element according to the invention.

According to another feature of the present invention, the diameter and the width of at least two kneading units may be different. This would result in an especially great variability of the shearing clearance. A screw element designed in this way could also be best suited to a widest variety of process tasks. Good shear introduction and a balanced exposure of the shear element to stress can be realized, when the diameter as well as the width of the kneading units increase in processing direction.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic plan view of a first embodiment of a screw element according to the present invention with variable diameter;

FIG. 2 is a schematic side view of the screw element of FIG. 1;

FIG. 3 is a schematic plan view of a second embodiment of a screw element according to the present invention with variable width; and

FIG. 4 is a schematic side view of the screw element of FIG. 3.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

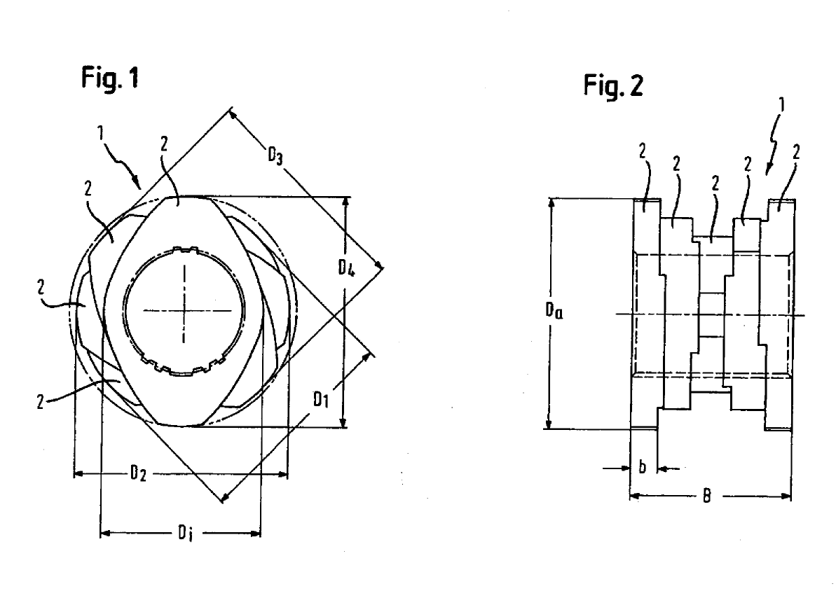

Turning now to the drawing, and in particular to FIG. 1, there is shown a schematic plan view of a first embodiment of a screw element according to the present invention, generally designated by reference numeral 1 and representing a kneading element for use in an unillustrated plasticizing unit.

The kneading element 1 is comprised of kneading units 2 which are firmly connected to one another. The kneading units 2 can be arranged on a common axis, for example a screw shaft (not shown). The kneading units 2 have hereby a toothed surface which is engageable with a toothed surface of the screw shaft so that the kneading element 1 is secured on the screw shaft in substantial fixed rotative engagement. The kneading units 2 have a geometry which is determined by two diameters Dᵢ and Dₐ, i.e. the diameters D₁ and D₂, D₃, or D₄.

The geometry of two kneading units 2 arranged in succession varies hereby. The kneading element 1 shown in FIG. 1 is configured such that the outer diameter Dₐ increases in processing direction. This means that the kneading unit 2 with the smallest diameter D₁ is arranged in this exemplary embodiment closest in the direction of a feeding zone, and the kneading unit 2 with the smallest diameter D₄ is arranged farthest in the direction of a discharge zone. Thus, in the exemplary embodiment shown here, D₄ is greater than D₃, and D₃ is greater than D₂. D₁ is again smaller than D₂, i.e. D₁<D₂<D₃<D₄. The inner diameter Dᵢ of the kneading element 1 remains hereby constant. For each configuration, it is conceivable to vary the inner diameter Dᵢ in correspondence to or differently than the outer diameter Dₐ,

FIG. 2 shows a schematic side view of the kneading element 1 shown in FIG. 1. The kneading element 1 of this exemplary embodiment has a total width B. The kneading units 2 in turn have a width b.

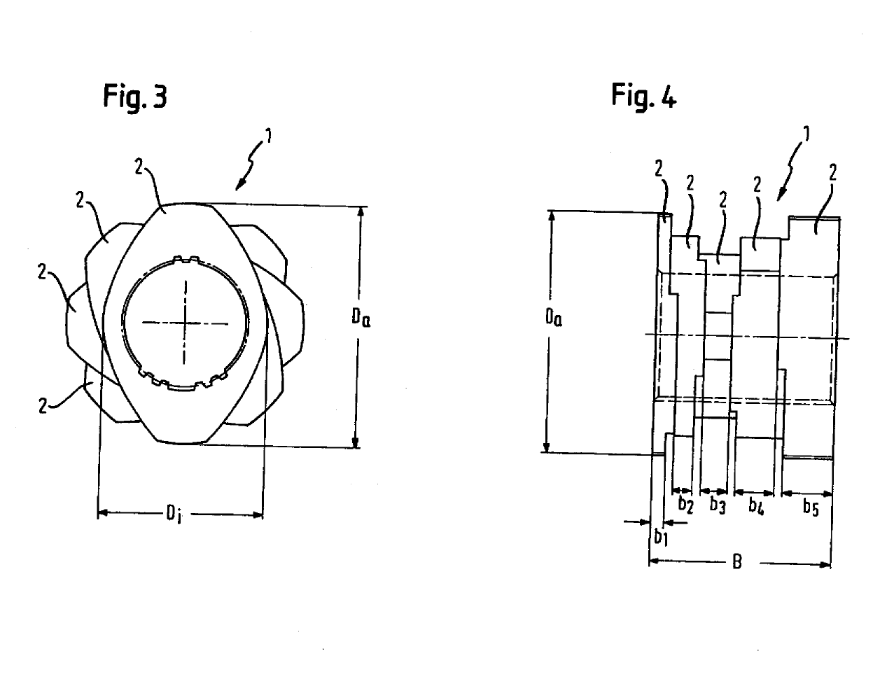

FIG. 3 shows a kneading element according to the invention with variable land width, i.e. the kneading units 2 have different widths b. The diameter ratio Dₐ/Dᵢ is constant in this exemplary embodiment. It should further be taken into account that the outer diameter Dₐ is also constant. The width b of the kneading units 2 increases in processing direction. As a result, the material shear is higher across the width B of the kneading element 1. As shown by way of example in FIG. 4, the width b₁ of the kneading unit 2, disposed closest in the direction of the feeding zone for this kneading element 1, is smaller than the width b₂. The width b₂ is again smaller than the width b₃. The width b₄ of the next kneading unit 2 is again greater than the width b₃ of the preceding kneading unit 2. Further, the width b₅ of the kneading unit 2, which in relation to this kneading element 2 is arranged farthest in direction discharge zone, is greater than the width b₄, i.e. b₁<b₂<b₃<b₄<b₅.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A kneading element for a plasticizing unit, comprising at least three kneading units arranged successively on a common axis, said kneading units having a width which increases overall in a processing direction.

2. The kneading element of claim 1, wherein successive ones of the kneading units have a same width.

3. The kneading element of claim 1, further comprising a screw shaft for defining the common axis.

4. The kneading element of claim 1, wherein one of the kneading units is defined by a first diameter, and another one of the kneading units is defined by a second diameter which is different than the first diameter.

5. The kneading element of claim 4, wherein the first and second diameters increase in the processing direction.

6. The kneading element of claim 1, wherein one of the kneading units is defined by a first diameter and a first width, and another one of the kneading units is defined by a second diameter and a second width, said first and second diameters being different and said first and second width being different.
